(19) United States
(12) Patent Application Publication
(10) Pub. No.: US 2012/0110039 A1
(43) Pub. Date: May 3, 2012

(54) System and Method for Storage and Retrieval of Electronic Documents

(75) Inventors: Gavin Brent McKay, Manuka (AU); Allan John King, Manuka (AU); Damien Glenn Jolly, Manuka (AU)

(73) Assignee: INVIZION PTY LTD, Manuka, Australian Capital Territory (AU)

(21) Appl. No.: 13/319,505

(22) PCT Filed: May 4, 2010
(86) PCT No.: PCT/AU2010/000512

§ 371 Date: Jan. 18, 2012

Related U.S. Application Data
(60) Provisional application No. 61/176,703, filed on May 8, 2009.

(51) Int. Cl. G06F 17/30

(52) U.S. Cl. 707/822; 707/E17.01

(57) ABSTRACT

The present invention is directed to a system and method of determining where electronic documents are stored. The system and method of the present invention analyses the metadata of a document, and determines status attributes of the document based on the metadata. The document is then stored in an appropriate storage system based on the status attribute of the document. The metadata of the document includes usage patterns.

### FIELD OF THE INVENTION

The present invention relates to the management of electronic documents. More particularly, it concerns a system and method for managing the storage and retrieval of electronic documents in a computer environment.

### DESCRIPTION OF THE RELATED ART

There are a number of ways organisations may look to implement information lifecycle management strategies to manage information throughout its useful life.

Generally, storage devices are administered based on business rules or policy, governing the length of time particular electronic information, such as a document, remains available on a particular storage device.

For example, a frequently accessed document may be allocated fast and highly available network storage. However, as the document becomes less-frequently accessed it may be allocated slower and less expensive storage. The document may finally be removed from storage or deleted once a certain retention period has expired, according to the business rule or policy.

As will be appreciated, the only attribute used to determine storage allocation in prior art systems, is time. In many cases, time attributes will be inappropriate to determine where a document is to be stored. For example, certain documents may need to be retrieved for legal matters, such as litigation. In order for such documents to be exempt from traditional time-based storage policies, an administrator or records manager must place a hold or freeze on the document to ensure it is not inadvertently removed from storage should it pass the retention date.

The present invention advantageously provides an alternative to existing storage procedures. The system and method according to certain embodiments of the present invention may advantageously be used to allow the administration of storage of electronic documents based on attributes other than time, to effectively and efficiently manage resources.

### SUMMARY OF THE INVENTION

According to a first aspect of the invention, there is provided a system and method of determining where electronic documents are stored. The system and method of the present invention analyses the metadata of a document, and determines status attributes of the document based on the metadata. The document is then stored in an appropriate storage system based on the status attribute of the document. The metadata of the document includes usage patterns.

According to another aspect of the invention, there is provided a computer file system interacting with a number of data storage devices. The system includes means for analysing the metadata of a document, as well as means for determining status attributes of the document based on the metadata. An allocation module is also included for storing the document in an appropriate storage system chosen from the data storage devices, wherein the allocation module allocates the appropriate data storage device based on the status attribute of the document.

In accordance with yet another aspect of the invention, there is provided a system and method for determining usage patterns of an electronic document in a computer environment. The system and method of the present invention receives metadata associated with the electronic document, and identifies commonalities in the metadata. Usage patterns are then determined based on the commonalities in the metadata.

According to another aspect of the invention, there is provided a method for allocating storage space in a computer file system interacting with Microsoft Office SharePoint Server 2007 and having a number of data storage devices. The method includes analysing the metadata of a document received from Microsoft Office SharePoint Server 2007, and determining status attributes of the document based on the metadata. The document is then stored in an appropriate storage system based on the status attribute of the document.

### BRIEF DESCRIPTION OF THE DRAWINGS

The invention will now be described in a non-limiting manner with respect to a preferred embodiment in which:

FIG. 1 is an overview of a preferred embodiment of the present invention.

FIG. 2 is an exemplary flow chart identifying status attributes based on usage patterns in accordance with a preferred embodiment of the present invention.

FIG. 3 is an interface with an enterprise server system in accordance with a preferred embodiment of the present invention.

FIG. 4 demonstrates the sub-systems within the software suite in accordance with a preferred embodiment of the present invention.

### DETAILED DESCRIPTION OF PREFERRED EMBODIMENTS

The following description of preferred embodiments is not intended to limit the scope, configuration or applicability of the invention. An enabling description of at least one preferred embodiment is provided to allow the person skilled in the art to implement the invention. It is to be understood that the following description has been provided only by way of exemplification of this invention, and that further modifications and improvements thereto, as would be apparent to persons of skill in the art, are deemed to fall within the broad scope and ambit of the current invention described and claimed herein.

Furthermore, the following described embodiments may be implemented by hardware, software, firmware, middleware, microcode, hardware description languages, or the like, or any combination thereof. When implemented in software, firmware, middleware or microcode, the program code or code segments to perform the necessary tasks may be stored in a machine readable medium such as storage medium. One or more processors may perform the described methodology. A code segment or computer-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the following discussion and in the claims that follow, the term “computer-readable medium” is to be given a broad meaning and includes both portable or fixed storage devices, optical storage devices, wireless channels and various other mediums capable of storing, containing or carrying instructions and/or data.

Additionally, in the following discussion and in the claims that follow, the terms “including” and “includes” are used, and are to be read, in an open-ended fashion, and should be interpreted to mean “including, but not limited to . . . ”.

Further, in the following discussion and in the claims that follow, the term “status attribute” is to be given a broad meaning and relates to the set of data used by the system of the present invention to determine the required storage appropriate to the particular electronic document or information. Unless specifically referred to otherwise, this term does not encompass time-based data.

In the following discussion and in the claims that follow, the term “time-based attribute” is to be given a broad meaning and relates to the age or access date of a particular electronic document or information, used by the system of the present invention to determine appropriate storage.

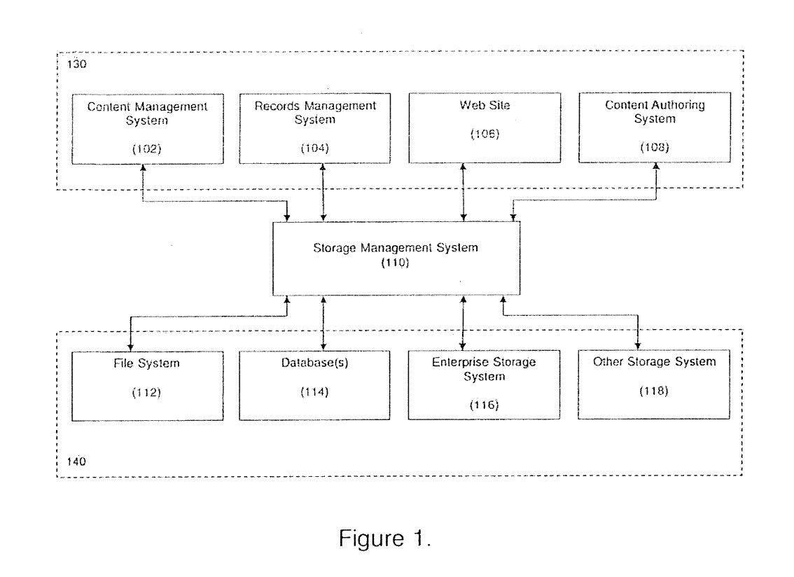

An overview of an embodiment of the system of the present invention is shown at FIG. 1. As shown, the system includes a storage management system 110 in accordance with the present invention. Various file management systems 130 interact with the storage management system 110. For example, Microsoft Office SharePoint Server 2007 may be implemented as a Content Management System 102.

A Records Management System 104, such as TRIM (Total Records and Information Management), preferably uses the Storage Management System 110 to store all electronic documents submitted to the Records Management System 104.

A Web Site 106, such as Microsoft Internet Information Server, that stores and/or provides access to electronic documents preferably uses the Storage

Management System 110 of the present invention to store any documents submitted to the site or stored on the site.

A Content Authoring System 108, such as Microsoft Word, could use the Storage Management System 110 to save and open any documents.

The Content Management System 102 logs all access requests to its database system, including but not limited to, the creation of the electronic document or information; deletion of certain particulars of the electronic document or information; updates made to the electronic document or information; and user read and access times of the electronic document or information.

As will be appreciated by those of skill in the art, the information is collected in audit logs within the Content Management System 102 and is available via web services, native object models, and/or the Content Management System database.

According to a preferred embodiment of the present invention, the Storage Management System 110 collects the relevant data and uses it to perform inspection of its time-based attributes. Additionally, usage patterns of the electronic document or information are determined by the system 110 to generate status attributes.

Usage patterns may include the analysis of peak times that a document is accessed to determine the most appropriate location for the document to be stored. For example, if a certain document is heavily accessed from 4 pm to 5 pm on Fridays, but not on other days, the Storage Management System 110 preferably allocates additional resources for this time period to ensure the system operated at peak performance levels. A status attribute in this example would be to indicate peak usage times.

Another usage pattern identified in accordance with a preferred embodiment of the present invention is analysing which group of people accessed a document the most. For example, if a certain document was accessed by people in one city, but not by people in another, the Storage Management System 110 could manage the document to a location that helped reduce latency when accessing the electronic document. A status attribute in this example would be to indicate geographic usage.

A further usage pattern in accordance with the present invention is analysing the sensitivity of electronic documents by using document metadata to establish security classifications. For example, if a group of documents were created with a security classification, then the Storage Management System 110 could set a status attribute to indicate the documents were classified.

Another usage pattern in accordance with a preferred embodiment of the present invention would be analysing the amount of metadata that had been added to a set of documents to verify that it matched corporate compliance policies. For example, if all documents have to have a Content Expert assigned in the document metadata properties, the Storage Management System 110 could set a status attribute to indicate which documents were non-compliant.

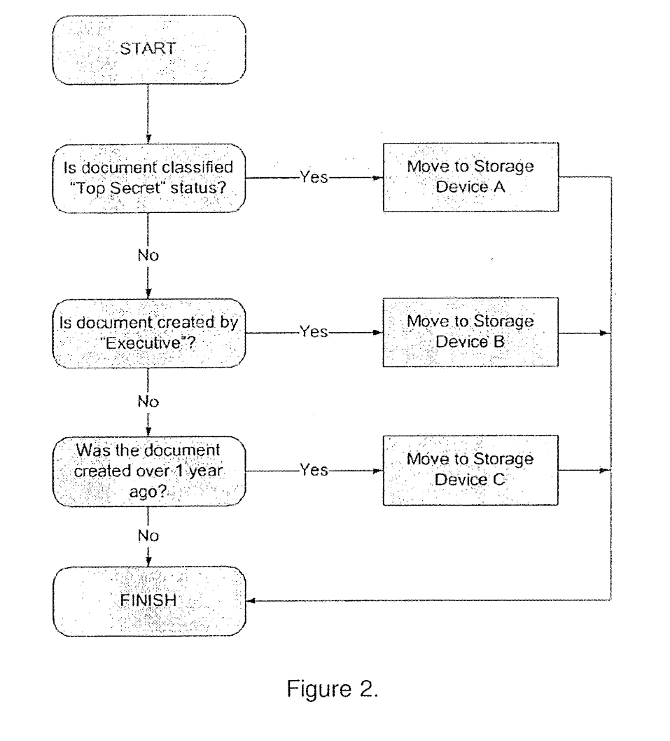

It will be appreciated by those of skill in the art that other usage patterns could be implemented to generate a relevant status attribute to determine document storage. An exemplary flow chart identifying status attributes based on usage patterns is shown in FIG. 2.

Status attributes generated as a result of the analytical process allow for the determination of document routing decisions, according to relevant business rules or policy. For example, highly active documents may be managed to quick-read storage devices, and read-only documents may be managed to memory cache for instant access. Further, large documents that are heavily edited may be managed to quick-write storage devices, whereas documents that are accessed predominantly via remote locations are managed to storage devices that are physically, closer to the user's location, reducing network bandwidth usage. It will be appreciated that other status attributes can be generated, depending on administration requirements and general business governance.

Preferably, the system of the present invention provides functionality to dynamically track disk usage of managed storage devices. The system preferably balances storage system usage by moving documents between lesser used storage devices. This allows users to fully utilise available storage infrastructure without having to purchase additional storage devices. It will be appreciated that applied business rules and policies will require certain documents to be stored on relevant storage devices depending on security issues for example, and the system of the present invention may accommodate this by overriding any balancing.

Additionally, and according to a preferred embodiment of the present invention, the system allows administrators to remotely manage storage devices. The system supports remote administration tools, as well as integration with administration products such as Microsoft's System Centre, for example. Accordingly, the system may be seamlessly integrated into existing enterprise system monitoring tools.

It will be appreciated that the system of the present invention may preferably utilise present inbuilt functionality of existing systems, such as file compression and space management, to reduce storage requirements by making more efficient use of disk space.

It will be further appreciated that the system of the present invention will provide support for a number of different storage products and vendors, including but not limited to:
Network file shares;
Microsoft SQL Server;
Oracle;
EMC CLARiiON; and
Symantec Storage Vault

The system may also provide a standard interface that allows additional products to be easily added. Further, the system preferably supports multiple systems accessing information through multiple applications at the same time.

A preferred embodiment of the present invention will now be described by way of example with reference to the Microsoft Office SharePoint Server 2007. It will be appreciated that the system of the present invention may be implemented to other enterprise server systems comprising content management systems, portals, collaboration, and business search and process.

Microsoft Office SharePoint Server 2007 provides a single, integrated location where users can collaborate with team members, find organizational resources, search for corporate information, manage content and workflow, and leverage business insight. It has sold over 100 million licences worldwide, and is rapidly growing in the corporate enterprise space.

Microsoft Office SharePoint Server 2007 has a number of features to address scalability and performance. However, it suffers from a number of shortfalls regarding management of the physical storage environment. Microsoft Office SharePoint Server 2007 will only utilise its own storage mediums (either Microsoft SQL Server 2005 or Microsoft SQL Server 2000) as its primary storage devices for electronic documents and information. As enterprise sites add documents to Microsoft Office SharePoint Server 2007 it can quickly result in storage size problems, which affects performance, stability, maintenance, and the ability for system administrators to control their storage environment.

Using the provided technology interfaces of Microsoft Office SharePoint Server 2007, the system of the present invention provides administrators with capability to control how, when and where Microsoft Office SharePoint Server 2007 stores its electronic documents. Administrators can dynamically adapt to the usage requirements of their SharePoint deployments.

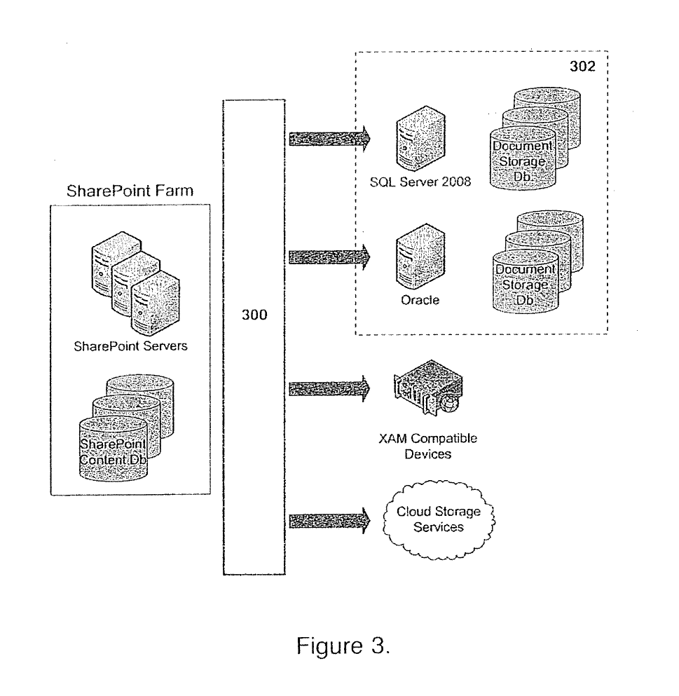

FIG. 3 shows a preferred high-level interface between Microsoft Office SharePoint Server 2007 and the system of the present invention. Documents are intercepted from SharePoint by the storage management system 300 and stored in the system repositories 302 according to a set of configurable storage rules that route documents to their appropriate repository, which may or may not be based on status attributes.

A configurable storage rule evaluates one or more conditions and routes a document to a preset location based on the evaluation result. For example, a configurable storage rule may state that all documents marked as “Highly Protected” must be stored on a secure storage device, while all document marked as “Unprotected” must be stored on a less-secure storage device.

The system of the present invention allows administrators the flexibility to utilise existing physical storage repositories, as well as adapt to additional storage as required by the organisation. This ensures maximum usage of existing hardware resources and provides a migration path that adapts to the organisation's future IT direction.

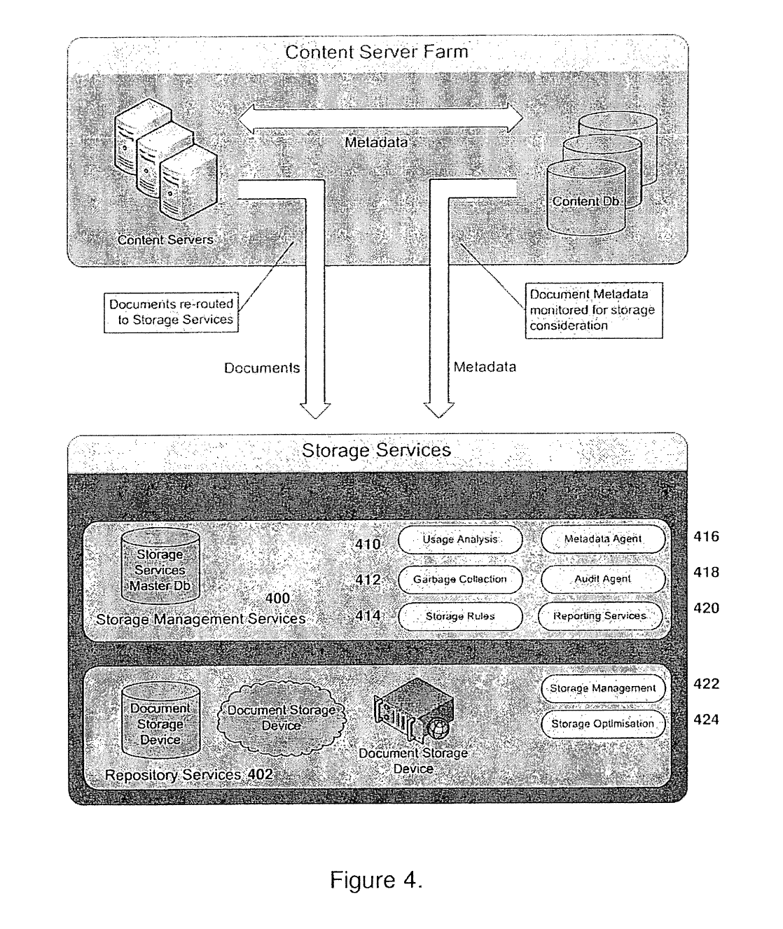

FIG. 4 illustrates the sub-systems within the software suite in accordance with a preferred embodiment of the present invention. The architecture of the present system is preferably built using Microsoft .NET 3.5 Framework and Microsoft SQL Server 2008 interacting with Microsoft Office SharePoint Server 2007. It will be appreciated by those of skill in the art that other suitable technologies may be implemented.

Microsoft Office SharePoint Server 2007 has an in-built interface called the External Blob Storage that is used to hand off the responsibility of document storage and retrieval to a third party component. The storage management services 400 of the present invention are a set of components that control the storage and retrieval of electronic documents on behalf of Microsoft Office SharePoint Server 2007. The following non-exhaustive exemplary storage management services are provided by the system:

Usage Analysis 410—The system of the present invention monitors all requests for storage and retrieval, and logs access to documents. Usage is utilised by the system to generate time-based attributes and status attributes, ensuring that documents are stored in their optimum location for storage and retrieval purposes. Usage trends may also be used to determine document value to the organisation;

Garbage Collection 412—The storage system preferably automatically cleans up unused document copies according to generated time-based attributes and/or status attributes relating to relevant business rules and policies. As will be appreciated, this can be completely configured by administrators to suit organisational requirements;

Storage Rules 414—Customised rules controlled and configured by an administrator instruct the system of the present invention how to manage and control file storage. This ensures that administrators can utilise their storage repositories to make best use of their IT infrastructure;

Metadata Agent 416—According to a preferred embodiment of the present invention, the Metadata Agent 416 connects to Microsoft Office SharePoint 2007 in order to monitor any changes in document metadata. These status attributes are used by the Storage Rules 414 component to move documents to their appropriate storage repository;

Audit Agent 418—Preferably, this aspect of the invention accesses Usage Analysis 410 information to provide security information and supply data to search components of the system. The Audit Agent 418 enhances team collaboration in to Microsoft Office SharePoint 2007; and

Reporting Services 420—The component preferably utilises the in-built SQL Server 2008 Reporting Services functionality (or equivalent) to provide administrators with detailed reports on usage and status of the storage system. Administrators are able to create additional reports as required to further enhance the reporting capabilities.

The storage repository services 402 components according to preferred embodiments of the present invention control the physical data repositories that store documents for the SharePoint solution. The following non-exhaustive exemplary services are provided by the system according to the present invention:

Storage Management 422—These components provide administrators with complete control over physical storage devices available to the system. This includes, but is not limited to, adding, migrating between, removing, and monitoring physical devices in real-time, with little or no downtime to end users; and

Storage Optimisation 424—These services provide administrators with the ability to control the amount of storage utilised by the physical devices. For example, administrators can split physical devices into different storage tiers based on performance, capability, scalability, and security considerations. This provides enhanced capabilities to control document storage within the enterprise.

Preferably, the system of the present invention uses the abovementioned Microsoft-provided External Blob Storage interface to intercept requests for document storage and retrieval, diverting all requests to its own storage devices. This interface was released with Windows SharePoint Services 3.0 Service Pack 1, and is freely available from Microsoft (see for example: http://www.microsoft.com/downloads/details.aspx?FamilyId=4191A531-A2E9-45E4-B71E-5B0B17108BD2&displaylang=en). Once the document has been deposited in its relevant storage device, the system according to the present invention then manages the document on behalf of SharePoint.

The interface is preferably also utilised to optimise performance of the storage system. The system constantly monitors for document metadata changes to update status attributes and ensure that its storage rules are being adhered to. For example, if a document's status attribute is updated to reflect a different security classification (such as declassification from “Highly Protected” to “Protected”) then the document could be moved to a less secure storage device to reduce maintenance overhead.

The system of the present invention preferably also includes an open architecture model that allows storage vendors to create device drivers that will seamlessly operate with the system. This provides extensive flexibility for organisations to make use of existing storage infrastructure, as well as provide a migration path for additional storage devices as they are released to market.

It will be appreciated by those of skill in the art that the system of the present invention allows administrators to utilise alternative content storage devices, such as Microsoft SQL Server 2008, Oracle, Symantec Storagevault, EMC Rainfinity, file systems, and other enterprise storage devices. Additionally, by performing deep usage analysis to determine status attributes based on document usage trends for example, and modifying storage appropriately, administrators have complete control over which storage devices are used, down to the document level. Documents may be dynamically moved between storage devices to improve performance, removing downtime during document and storage migration, as well as providing extensive audit, performance and usage metrics. Advantageously, the system of the present invention allows administrators to adapt their storage requirements to meet their organisational needs, without being locked in to a single-vendor approach.

It is to be understood that the above embodiments have been provided only by way of exemplification of this invention, and that further modifications and improvements thereto, as would be apparent to persons skilled in the relevant art, are deemed to fall within the broad scope and ambit of the current invention described and claimed herein.

1. A method for determining where electronic documents are stored including the steps of:
analysing the metadata of a document;
determining status attributes of the document based on the metadata; storing the document in an appropriate storage system based on the status attribute of the document.

2. The method of claim 1, wherein the metadata includes usage patterns.

3. The method of claim 1, wherein the storing of the document in an appropriate storage system is also based on time-based attributes.

4. A computer file system interacting with a number of data storage devices, including:
means for analysing the metadata of a document;
means for determining status attributes of the document based on the metadata;
an allocation module for storing the document in an appropriate storage system chosen from the data storage devices;
wherein the allocation module allocates the appropriate data storage device based on the status attribute of the document.

5. The system of claim 4, wherein the metadata includes usage patterns.

6. The system of claim 4, wherein the allocation module allocates the appropriate data storage device based also on time-based attributes.

7. The system of claim 4, wherein the computer file system further interacts with a content management system.

8. A method for determining usage patterns of an electronic document in a computer environment, including:
receiving the metadata associated with the electronic document; identify commonalities in the metadata; and
determining a usage pattern based on the commonalities in the metadata.

9. The method of claim 8, wherein the metadata includes time-based attributes.

10. A method for allocating storage space in a computer file system interacting with Microsoft Office SharePoint Server 2007 and having a number of data storage devices, including the steps of:
analysing the metadata of a document received from Microsoft Office SharePoint Server 2007;
determining status attributes of the document based on the metadata; storing the document in an appropriate storage system;
wherein the document is stored based on the status attribute of the document.

11. The method of claim 10, wherein the metadata includes usage patterns.

12. The method of claim 10, wherein the storing of the document in an appropriate storage system is also based on time-based attributes.
